(19) United States
(12) Patent Application Publication
(10) Pub. No.: US 2003/0134012 A1
(43) Pub. Date: Jul. 17, 2003

(54) Soft candy unit

(75) Inventor: Herbert Mederer, Furth (DE)

Correspondence Address: BROWDY AND NEIMARK, P.L.L.C., 624 NINTH STREET, NW, SUITE 300, WASHINGTON, DC, 20001-5303, US

(73) Assignee: MEDERER GmbH, Furth (DE)

(21) Appl. No.: 10/340,816

(22) Filed: Jan. 13, 2003

(30) Foreign Application Priority Data
Jan. 12, 2002 (DE) 102 00 959.7

(51) Int. Cl. A23G 1/00

(52) U.S. Cl. 426/104

(57) ABSTRACT

A soft candy unit comprises two half shells of dimensionally stable plastic material, which combine to constitute a closed mold. They rest tightly on one another on a parting plane by rims which are at least partially linked to one another. The soft foamed sugar body rests planely on the inside of the half shells. This can give an impression of a toy article, for example in the shape of an eyeball with an iris and a pupil.

### BACKGROUND OF THE INVENTION

1. Field of the Invention

The invention relates to a soft candy unit comprising two half shells of dimensionally stable transparent plastic material, which combine to constitute a closed spherical mold, which rest on one another by rims on a parting plane, and which are linked to one another at least partially; and a soft foamed sugar body, which rests planely on the inside of the half shells.

2. Background Art

DE 40 04 688 A1 teaches a soft candy unit of the generic type in which two half shells, which are joined to each other, are filled and then shut so that a spherical candy body is produced. It is also possible to pour several layers.

A sweet toy in the shape of a burger is known from EP 0 349 841 B1. Two half shells are available, which rest on each other by flanged rims, constituting a closed cover. Several members of fruit gum or foamed sugar are arranged in this cover, copying a burger that includes two halves of a roll and intermediate layers. These parts are clamped in place in the cover, embodying the shape of a burger.

EP 0 931 872 B1 describes an improvement of this sweet toy, in which two layers of the burger at a time form a single piece.

### SUMMARY OF THE INVENTION

It is an object of the invention to further develop a soft candy unit of the generic type so that fantasy and creativeness are conferred on it, accompanied with the pleasure of enjoying a novel toy.

According to the invention, this object is attained in a soft candy unit by the features which consist in that the soft foamed sugar body forms an eyeball, the iris and pupil of which are arranged at the zenith of a half shell; in that the iris consists of edible gum mass of transparent colors; and in that the pupil consists of a lenticular sweet that is placed into the iris. The soft sweet, which substantially consists of a soft foamed sugar body, is arranged inside the closed mold, resting positionally stably by its full surface on the inside wall. It combines with this mold to form the soft candy unit so that the quality of a toy that resides in every individual unit includes the mold comprised of half shells and the soft foamed sugar body. The soft foamed sugar body has the shape of an eyeball, it being possible to produce further characteristics on the surface of the eyeball by imprints on the mold of transparent plastics. Being in no way connected with the mold, the body is easy to remove and fit to eat.

Further features, advantages and details of the invention will become apparent from the ensuing description of an exemplary embodiment, taken in conjunction with the drawing.

### BRIEF DESCRIPTION OF THE DRAWING

FIG. 1 is a plan view of two half shells;

FIG. 2 is a vertical sectional view of the two half shells according to FIG. 1;

FIG. 3 is a plan view of a soft candy unit when the half shells are shut;

FIG. 4 is a lateral view of the soft candy unit of FIG. 3; and

FIG. 5 is a lateral view of the soft candy unit rotated by 90° as compared to FIG. 4.

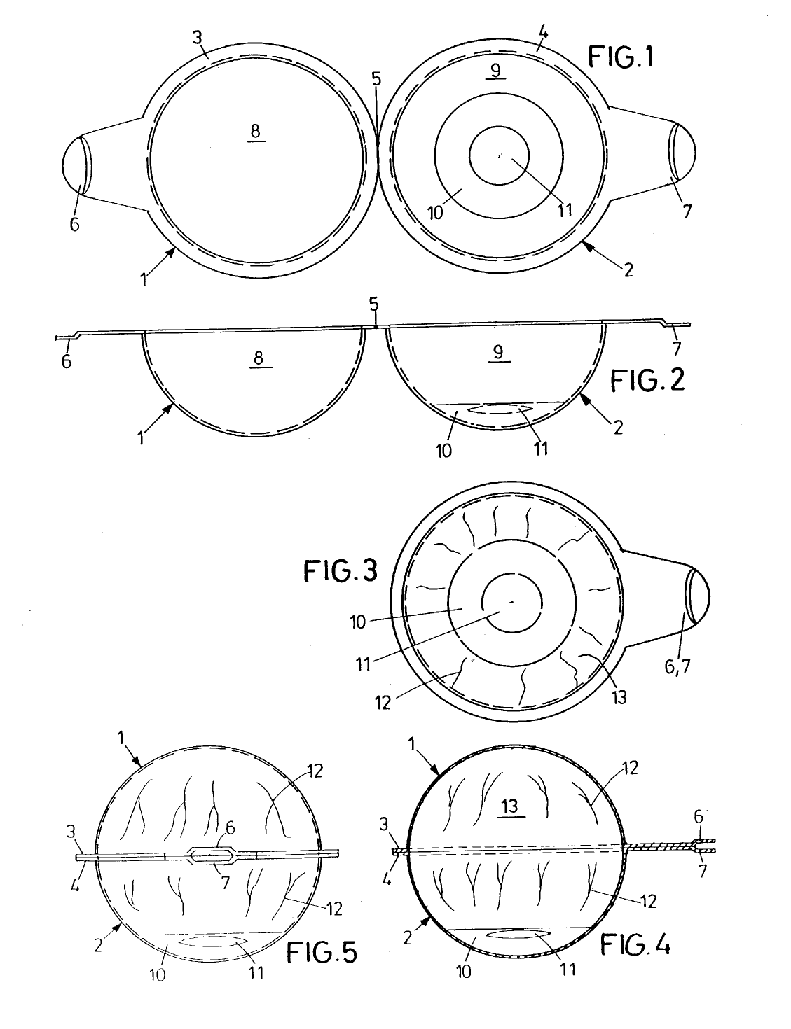

### DESCRIPTION OF THE PREFERRED EMBODIMENT

Two semispherical half shells 1, 2 of thin, positionally stable i.e., rigid, transparent plastic film each have a flanged rim 3, 4 which projects radially on a joint center plane. The flanged rims 3, 4 are linked to one another by an integral hinge 5 i.e., the two half shells 1, 2 form a unit. A lug 6, 7 is provided on each of the ends that are opposite the integral hinge 5.

The two half shells 1, 2 are filled with semispherical constituent bodies 8 and 9, which are poured into the shells, reaching as far as the center plane formed by the respective flanged rim 3, 4. One half shell 1 holds a constituent body 8 exclusively of soft foamed sugar mass, for example of white color. Poured into the other half shell, centrally at the bottom, is edible gum mass of transparent colors, with the finished soft candy unit giving the impression of an iris. This ball segment that copies the iris 10 has a color which strongly contrasts the color of the constituent body 9. Arranged in the iris 10 is a lenticular body of an edible compound which copies a pupil 11. The rest of the constituent body 9, same as the constituent body 8, consists of soft foamed sugar mass. The half shells 1, 2 have an imprint 12, which may for instance illustrate red veinlets.

FIGS. 3,4 and 5 show the finished product. The half shells 1, 2 rest closely on one another by the flanged rims 3, 4, where they are tightly, but detachably united for example by ultrasonic welding. The two constituent bodies 8, 9 are united and glued together along the parting plane defined by the flanged rims 3, 4 so that they form a one-piece and integral soft foamed sugar body 13. When the mold that is formed by the half shells 1, 2 is torn open, the body 13, which rests planely on the inside of the half shells 1, 2, can be removed as a uniform piece.

What is claimed is

1. A soft candy unit, comprising
two half shells (1, 2) of dimensionally stable transparent plastic material,
which combine to constitute a closed spherical mold, and
which rest on one another by rims (3, 4) on a parting plane, and
which are linked to one another at least partially; and
a soft foamed sugar body (13), which rests planely on the inside of the half shells (1, 2);
wherein the soft foamed sugar body (13) forms an eyeball, the iris (10) and pupil (11) of which are arranged at the zenith of a half shell (2);
wherein the iris (10) consists of edible gum mass of transparent colors; and
wherein the pupil (11) consists of a lenticular sweet that is placed into the iris (10).

2. A soft candy unit according to claim 1, wherein the rims are flanged rims (3, 4).

3. A soft candy unit according to claim 1, wherein the rims (3, 4) are welded together.

4. A soft candy unit according to claim 1 or 2, characterized in that the rims (3, 4) are flexibly interlocked.

5. A soft candy unit according to claim 1, wherein the rims (3, 4) are linked to one another by an integral hinge (5).

6. A soft candy unit according to claim 1, wherein lugs (6, 7) are formed on the rims (3, 4).

7. A soft candy unit according to claim 1, wherein a pattern, which is allocated to the soft foamed sugar body (13), is imprinted on at least one half shell (1, 2).
